(19) United States
(12) Patent Application Publication
(10) Pub. No.: US 2016/0178062 A1
(43) Pub. Date: Jun. 23, 2016

(54) BRUSH SEAL ARRANGEMENT

(71) Applicant: SIEMENS AKTIENGESELLSCHAFT, Munich (DE)

(72) Inventor: Andreas Hofmann, Gerhardshofen (DE)

(73) Assignee: SIEMENS AKTIENGESELLSCHAFT, Munich (DE)

(21) Appl. No.: 14/905,060

(22) PCT Filed: Jul. 8, 2014
(86) PCT No.: PCT/EP2014/064536

§ 371 Date: Jan. 14, 2016

(30) Foreign Application Priority Data
Aug. 26, 2013 (DE) 102013216933.7

(51) Int. Cl. F16J 15/3288; F01D 11/00

(52) U.S. Cl. CPC F16J 15/3288; F01D 11/00; F05D 2240/56; F05D 2220/31

(57) ABSTRACT

A brush seal arrangement for sealing a gap between a rotor and a stator includes a brush housing and a plurality of bristles fastened in the brush housing. The free ends of the bristles are supported against a sealing surface on the rotor. Radially circumferential relief grooves are provided on the rotor before and after the sealing surface in an axial direction, such that a ridge is formed in the region of the sealing surfaces, which ridge can deform locally, in particular when the brush housing rubs against the sealing surface, whereby the risk of distortion of the rotor and thus the occurrence of dangerous spiral oscillations can be minimized. A steam turbine has such a brush seal arrangement.

### CROSS REFERENCE TO RELATED APPLICATIONS

This application is the US National Stage of International Application No. PCT/EP2014/064536 filed Jul. 8, 2014, and claims the benefit thereof. The International Application claims the benefit of German Application No. DE 102013216933.7 filed Aug. 26, 2013. All of the applications are incorporated by reference herein in their entirety.

### FIELD OF INVENTION

The invention relates to a brush seal arrangement for sealing a gap between a rotor and a stator. Furthermore, the invention relates to a rotary machine, in particular a steam turbine.

### BACKGROUND OF INVENTION

Brush seals have the task of sealing the gap between a rotor and a stator and thus of keeping the leakage of process fluid through the gap between the rotor and stator as low as possible. For this purpose, the brush seal has a brush housing and a plurality of bristles fastened in the brush housing. The bristles project from the brush housing and are supported by their free ends against a sealing surface on the rotor. Depending on the embodiment of the brush seal, the bristles of the brush seal are supported permanently against the sealing surface on the rotor, or the free ends of the brush seal bear locally against the sealing surface of the rotor only during a radial movement of the rotor in operation. Brush seals are used in particular in compensating pistons and in the blading path of steam turbines.

When designing brush seals, care must be taken to ensure that, in the event of a rotor-stator contact, the risk of spiral oscillations is excluded and thus a stable operation for all operating states can be ensured. The dangerous spiral oscillations occur if a distortion of the rotor occurs as a result of the rotor rubbing against the stator (or against the brush housing).

### SUMMARY OF INVENTION

It is an object of the invention to provide a brush seal which excludes or at least considerably reduces the risk of spiral oscillations. Furthermore, it is an object of the invention to provide a steam turbine having such a brush seal.

The invention is achieved with regard to the brush seal arrangement and with regard to the rotary machine by the features of the independent patent claims.

Exemplary embodiments of the invention which can be used on their own or in combination with one another form the subject-matter of the subclaims.

The brush seal arrangement according to the invention for sealing a gap between a rotor and a stator, comprising at least one brush seal which has a brush housing and a plurality of bristles fastened in the brush housing, wherein the free ends of the bristles can be supported against a sealing surface on the rotor, is distinguished by the fact that radially circumferential relief grooves are provided on the rotor in front of and behind the sealing surface in the axial direction, with the result that a rib is formed in the region of the sealing surface, which rib can deform locally, in particular when the brush housing rubs against the sealing surface. The local deformation of the rib means that a distortion of the rotor is largely avoided, with the result that dangerous spiral oscillations can be largely avoided. Consequently, the operational safety of the rotor-stator unit is substantially increased. A further positive effect of the relief grooves is the cooling action of the steam within the relief groove. Specifically, very high temperatures occur locally in the region of the rib as a result of the brush seal rubbing against the sealing surfaces.

In order to overcome high pressure differences, a plurality of brush seals are advantageously arranged axially behind one another.

The rotary machine according to the invention, in particular a steam turbine, is distinguished by the fact that the rotary machine comprises a brush seal arrangement according to the invention. As a result of the use of the brush seal arrangement according to the invention, the risk of a distortion of the rotor and thus the occurrence of dangerous spiral oscillations is avoided or at least greatly reduced. Consequently, safety when using brush seals in rotary machines, such as, for example, in steam turbines, gas turbines and compressors, is substantially increased.

### BRIEF DESCRIPTION OF THE DRAWINGS

FIG. 1 shows an exemplary embodiment of a brush seal arrangement of the invention.

### DETAILED DESCRIPTION OF INVENTION

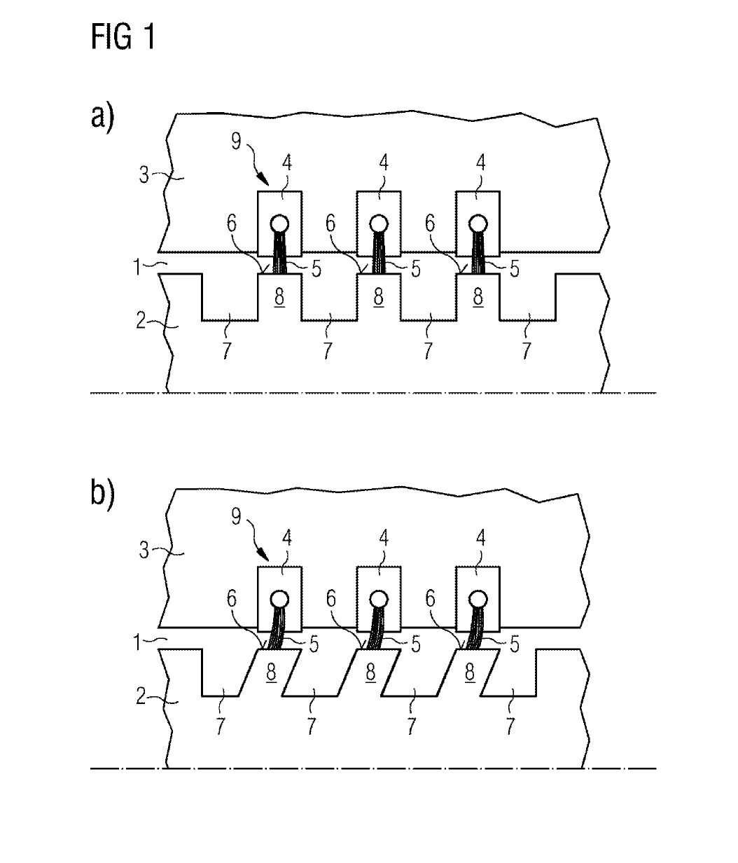

FIG. 1 shows a brush seal arrangement according to the invention. The brush seal arrangement comprises three brush seals 9 which are arranged radially behind one another and which are arranged in a stator 3. The stator 3 is, for example, the housing of a steam turbine. Each brush seal 9 comprises a brush housing 4 in which there are arranged a plurality of bristles 5 fastened in the brush housing 4. The free ends of the bristles 5, which project from the brush housing 4, are supported against a sealing surface 6 on the rotor 2. As a result, the gap 1 between the rotor 2 and the steam turbine housing 3 is sealed. The brush seal 9 can be designed here such that the bristles 5 are supported permanently against the sealing surface 6 on the rotor 2, or the bristles 5 rub against the sealing surface 6 only during a radial deflection of the rotor 2. According to the invention, the rotor 2 is designed in such a way that a radially circumferential relief groove 7 is provided in front of and behind each sealing surface 6, with the result that a rib 8 is formed in the region of the sealing surface 6, which rib can deform when a load is applied to the rib 8. The local deformation of the ribs 8 is illustrated in FIG. 1. A strong radial deflection of the rotor 2 causes the brush seal 9 to rub against the sealing surfaces 6, with the result that very high temperatures occur locally. Consequently, the ribs 8 are deformed locally and substantially elastically.

Owing to the elastic deformation in the region of the ribs 8, a distortion of the rotor 2 is effectively prevented. Distortion of the rotor 2 would promote the occurrence of dangerous spiral oscillations.

The brush seal arrangement according to the invention thus provides for a substantially safer operation of the steam turbine. The brush seal can be used in particular for the shaft region in the steam turbine. Depending on the width and depth of the groove in the rotor, the possibility of local deformation for the rib can be influenced.

By virtue of the brush seal arrangement according to the invention, the risk of spiral oscillations in rotors at risk of distortion, in rotary machines, such as, for example, in steam turbines, gas turbines or compressors is minimized. Here, the design of the brush seal arrangement according to the invention is structurally very simple and cost-effective.

1. A brush seal arrangement for sealing a gap between a rotor and a stator, comprising
at least one brush seal which has a brush housing and a plurality of bristles fastened in the brush housing, wherein the free ends of the bristles are supported against a sealing surface on the rotor, and
radially circumferential relief grooves on the rotor in front of and behind the sealing surface in the axial direction, wherein a rib is formed in the region of the sealing surface, which rib can deform locally.

2. The brush seal arrangement as claimed in claim 1,
wherein the brush seal arrangement has a plurality of brush seals arranged behind one another in the axial direction.

3. A rotary machine, comprising:
a brush seal arrangement as claimed in claim 1.

4. The brush seal arrangement as claimed in claim 1,
wherein the rib can deform locally when the brush housing rubs against the sealing surface.

5. The rotary machine as claimed in claim 3,
wherein the rotary machine comprises a steam turbine.
